(19) United States
(12) Patent Application Publication
(10) Pub. No.: US 2022/0035883 A1
(43) Pub. Date: Feb. 3, 2022

(54) MANAGEMENT OF USER JOURNEYS THROUGH PREDEFINED COMMUNICATION ACTIVITIES

(71) Applicant: salesforce.com, inc., San Francisco, CA (US)

(72) Inventors: Scott Pitkin, San Francisco, CA (US); Pranavkumar Janakbhai Parekh, Bellevue, CA (US); Brian Brinegar, San Francisco, CA (US); Justin Prather, Indianapolis, IN (US); Matthew Zelenak, San Francisco, CA (US); Craig Whynot, San Francisco, CA (US); Ashwin Lulla, San Francisco, CA (US); Alicia Greer, San Francisco, CA (US); Rob Everetts, San Francisco, CA (US); James MacManus, San Francisco, CA (US); Andrew Short, San Francisco, CA (US)

(21) Appl. No.: 17/162,346

(22) Filed: Jan. 29, 2021

Related U.S. Application Data
(60) Provisional application No. 63/059,392, filed on Jul. 31, 2020.

(51) Int. Cl. G06F 16/9538; G06F 16/9537; G06F 16/9535; G06F 3/0484

(52) U.S. Cl. CPC G06F 16/9538; G06F 3/04842; G06F 16/9535; G06F 16/9537

(57) ABSTRACT

Methods, computer readable media, and devices for management of a user journey through predefined communications activities are presented. A method may include obtaining a contact identifier for one or more contacts, determining a journey for a contact corresponding to the contact identifier, determining a contact status for the contact, displaying a visual depiction of the journey and a visual depiction of the contact status for the contact, receiving an indication of a contact journey modification, generating an updated contact status, and displaying an updated visual depiction of the journey and the updated contact status for the contact.

### TECHNICAL FIELD

Embodiments disclosed herein provide techniques, systems, and interfaces to allow for managing communications and related activities with one or more users or groups of users via an interactive interface.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description explain the principles of implementations of the disclosed subject matter. No attempt is made to show structural details in more detail than can be necessary for a fundamental understanding of the disclosed subject matter and various ways in which it can be practiced.

FIGS. 1A-1B are block diagrams illustrating examples of various user journeys according to some example implementations.

FIGS. 1C-11 are block diagrams illustrating various screens of a graphical user interface for managing user journeys through predefined communication activities according to some example implementations.

FIG. 12 is a flow diagram illustrating a method for managing user journeys through predefined communication activities according to some example implementations.

FIG. 13A is a block diagram illustrating an electronic device according to some example implementations.

FIG. 13B is a block diagram of a deployment environment according to some example implementations.

### DETAILED DESCRIPTION

Various aspects or features of this disclosure are described with reference to the drawings, wherein like reference numerals are used to refer to like elements throughout. In this specification, numerous details are set forth in order to provide a thorough understanding of this disclosure. It should be understood, however, that certain aspects of disclosure can be practiced without these specific details, or with other methods, components, materials, or the like. In other instances, well-known structures and devices are shown in block diagram form to facilitate describing the subject disclosure.

Implementations of the disclosed subject matter provide methods, computer readable media, and devices for management of user journeys through predefined communication activities. In various implementations, a contact identifier for one or more contacts is obtained and a journey for a contact corresponding to the contact identifier is determined. The journey may include one or more paths and each path may include one or more actions to be performed in relation to the contact. A contact status representing a location of the contact along the journey may be determined for the contact. A visual depiction of the journey and of the contact status for the contact may be displayed via a graphical user interface (GUI). An indication of a contact journey modification may be received and an updated contact status for the contact based on the contact journey modification may be generated. In various implementations, an updated visual depiction of the journey and the updated contact status for the contact may be displayed via the GUI.

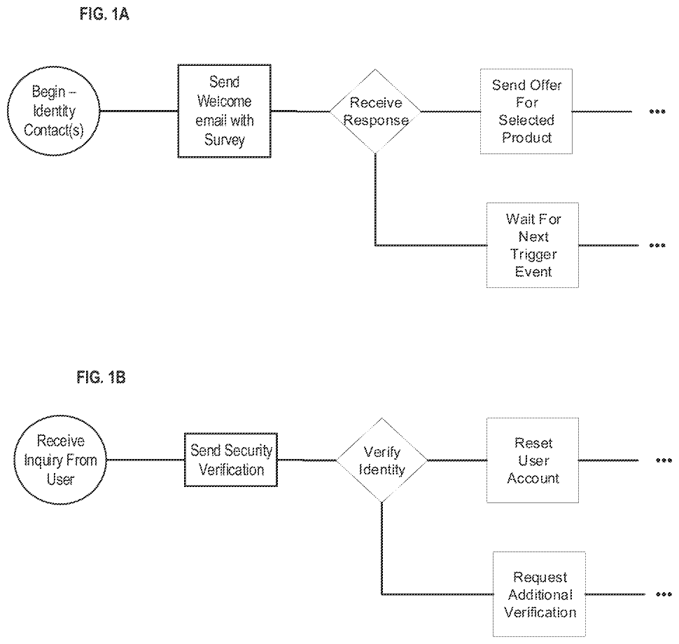

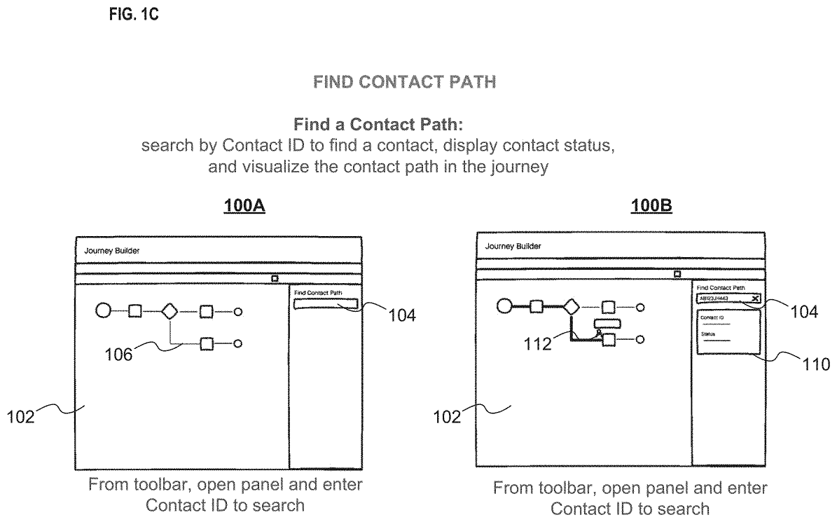

An initial interface as disclosed herein is shown in FIG. 1C. A user “journey” may be represented by a series of actions or activities, as shown by the linked circles, squares, and diamonds. Generally a “journey” includes a linked series of activities that drive interactions with a user, including email communications, SMS communications, mobile in-app messages, mobile app push notifications; as well as actions that occur during these interactions, including updates to user data, checking for dependencies, and wait durations. A user may be, for example, a customer of an enterprise that uses the interfaces shown herein to manage communications with the user. Each action or activity may be, for example, an electronic communication such as an email, text message, or the like, sent to the user by an enterprise; an offer such as a discount or advertisement; a purchase or other action taken by the user or expected to be taken by the user; a communication received from the user, or the like. The journey may show a potential series of actions that are expected to occur with respect to a user or a group of users. Specific examples of user journeys may include a series of events such as shown in FIG. 1A. This journey may represent, for example, a marketing campaign for identifying and communicating with a new potential customer via an email survey. As another example, a user journey for providing access to a secured resource after an initial user inquiry may include a series of events such as shown in FIG. 1B. Other actions and more complex journeys may be defined and used, and may include many other types of actions and logic.

Embodiments disclosed herein provide techniques to obtain information about a user or group of users that are already interacting with an enterprise via one or more journeys, and/or to analyze and modify the user interactions through the journey.

FIG. 1 shows an example interface and process for locating a user based on an identifier and viewing one or more journeys in which the user is engaged. For example, graphical user interface (GUI) screen 100A may include a canvas 102 and a search field 104. A journey 106 may be visually depicted on the canvas 102. As shown in GUI screen 100B, a portion of a path through the journey may be highlighted to indicate the current position of the user 112 on the journey. In addition, an error state may also be indicated, for example, if an error is returned for the user. If an error is returned, an error state may include, for example, an error name, error type, a date/time of occurrence, an action or information to resolve the error, or the like. Information about the user, the journey, the specific action at which the user is located within a journey, or any other information in the system may be displayed in a panel, such as contact panel 110.

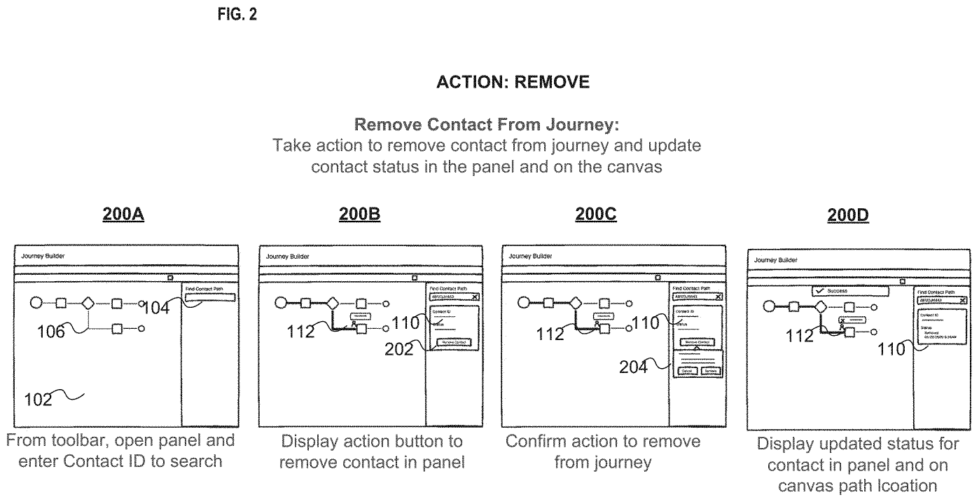

After a user or group of users is identified within the journey management system, various actions may be available to an operator of the system. For example, FIG. 2 shows an operation in which a user is removed from the journey (so that subsequent actions after the user's current position will not be taken), and updated information may be provided. Such a process may be useful, for example, when it is determined that a user should no longer be engaged via a particular journey, when the journey is no longer applicable to the user, or the like.

As shown in GUI screen 200A, journey 106 may be depicted on canvas 102 and search field 104 may be utilized to search for a particular contact. In GUI screen 200B, contact 112 may be visually depicted on the journey and information related to the contact may be displayed in contact panel 110 along with an action button 202. Action button 202 may, for example, provide an option to remove the contact from the journey. In GUI screen 200C, a confirmation window 204 may be presented. In GUI screen 200D, an updated status for the contact may be displayed within contact panel 110.

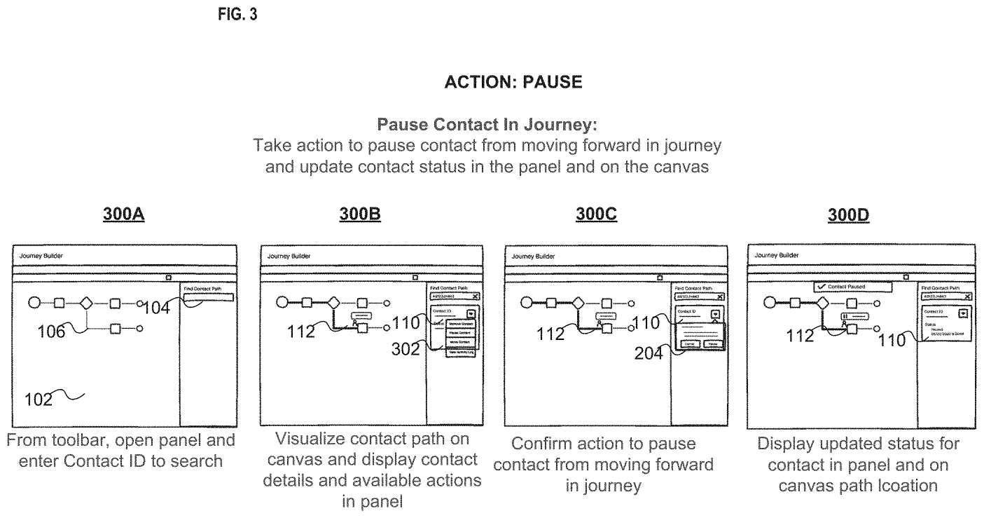

FIG. 3 shows another example in which a user may be “paused” within a journey, so that no further actions are performed until an operator of the system un-pauses the user's journey. Such a process may be useful, for example, when it is desired that other actions outside of a defined journey are performed before the user proceeds within the journey, or when events outside those defined within a journey have an impact on the operation or desirability of the journey for the user or the enterprise. For example, if a user has submitted a complaint about the enterprise's performance at an earlier step of the journey, it may be desirable to pause the journey and prevent further actions from being performed until the complaint is resolved.

As shown in GUI screen 300A, journey 106 may be depicted on canvas 102 and search field 104 may be utilized to search for a particular contact. In GUI screen 300B, contact 112 may be visually depicted on the journey and information related to the contact may be displayed in contact panel 110. In addition, available actions may be shown in action list 302. Available actions may include, for example, an option to pause the contact within the journey. In GUI screen 300C, a confirmation window 204 may be presented. In GUI screen 300D, an updated status for the contact may be displayed within contact panel 110.

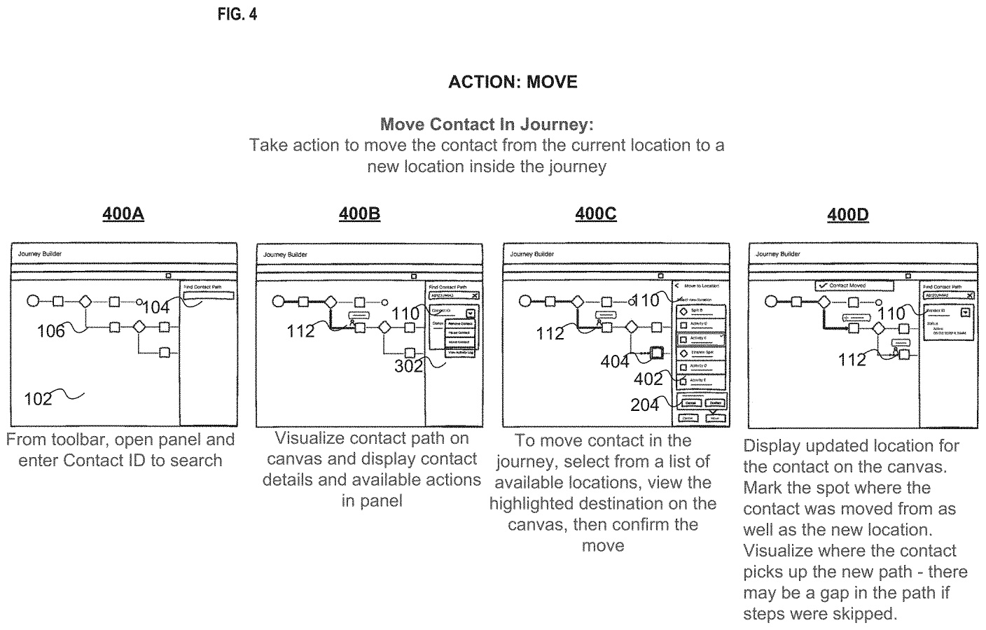

As another example, FIG. 4 shows a process for moving a user within a journey, for example to “skip” some activities within a journey. As shown in GUI screen 400A, journey 106 may be depicted on canvas 102 and search field 104 may be utilized to search for a particular contact. In GUI screen 400B, contact 112 may be visually depicted on the journey and information related to the contact may be displayed in contact panel 110. In addition, available actions may be shown in action list 302. Available actions may include, for example, an option to move the contact within the journey. As shown in GUI screen 400C, a list of available locations 402 may be displayed within contact panel 110 along with confirmation window 204. Once a new location is selected from list of available locations 402 and confirmed in confirmation window 204, the new location 404 may be visually depicted on canvas 102. For example, new location 404 may be shaded, darkened, or otherwise highlighted on canvas 102. Alternatively, or in addition, contacts may be moved directly via the GUI, for example via a “click and drag” operation that moves one or more contacts from one position in the journey to another. As shown in GUI screen 400D, contact 112 may be visually depicted at the new location and updated contact information may be presented in contact panel 110.

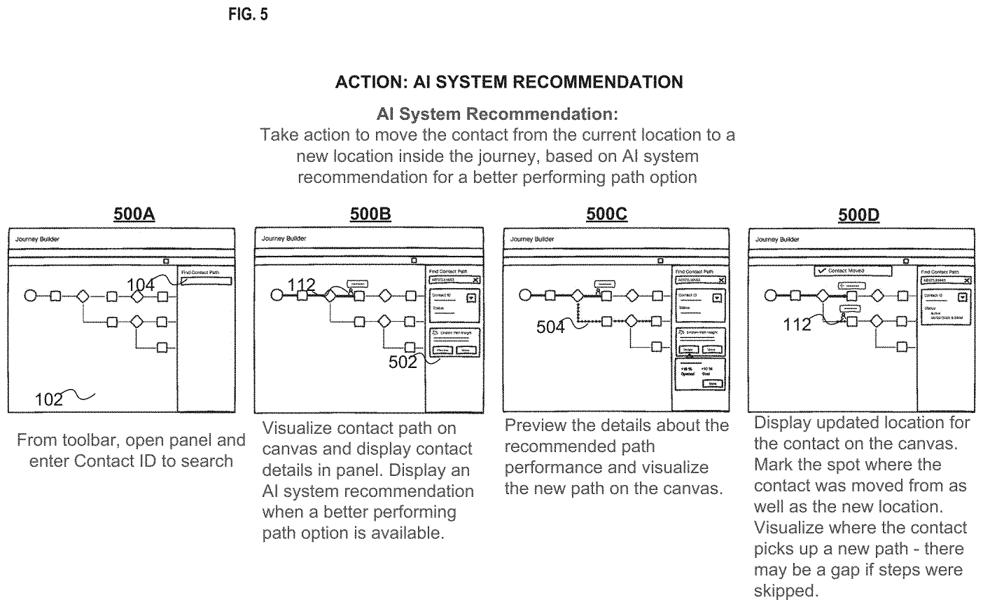

FIG. 5 shows an example of a process for automatically identifying an alternate journey or an alternate path within a journey, such as via a machine learning or other AI system. For example, a recommendation system may determine that a user is more likely to make a purchase from the enterprise if the user is moved to a different journey or a different path within the current journey. Such a recommendation may be made based on historical data for other similar users or the specific user being considered, in the same or similar journeys or journey paths. More generally, the recommendation system may operate independently of the journey analysis system, but may be able to provide recommendations regarding journey paths based on user behavior observed within and/or outside of the journey management system.

As shown in GUI screen 500A, a journey may be depicted on canvas 102 and a search field 104 may be utilized to search for a particular contact. In GUI screen 500B, contact 112 may be visually depicted on the journey. In addition, an AI System Recommendation button 502 may also be shown. As discussed above, an AI system recommendation may analyze the information related to the contact and recommend a different journey or a different path within the current journey. As shown in GUI screen 500C, a recommended path preview 504 may be visually depicted along with information about the recommended path. In GUI screen 500D, contact 112 may be visually depicted along the recommend path.

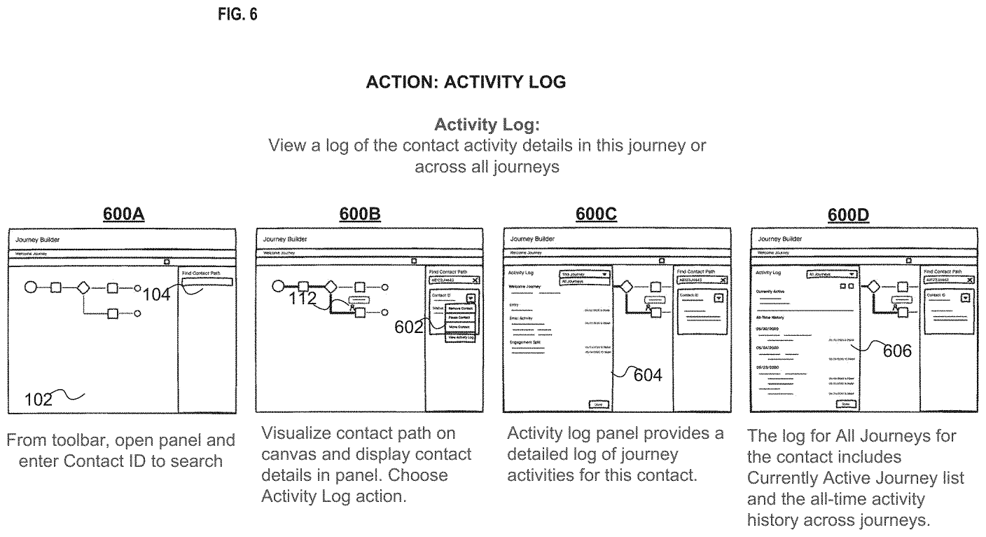

FIG. 6 shows an example process for locating and reviewing specific actions taken by the system and/or the user with respect to the journey on which the user is located. As shown in GUI screen 600A, a journey may be depicted on canvas 102 and a search field 104 may be utilized to search for a particular contact. In GUI screen 600B, contact 112 may be visually depicted on the journey and an action list 602 may be shown in a contact panel. Action list 602 may include, for example, an action to show an activity log related to contact 112. As shown in GUI screen 600C, an activity log panel 604 may provide a detailed log of journey activities for contact 112. Activity log panel 604 may also provide, for example, error or other information related to contact 112. As shown in GUI screen 600D, an all journeys log panel 606 may provide a currently active journey list and an all-time activity history across all journeys for the contact.

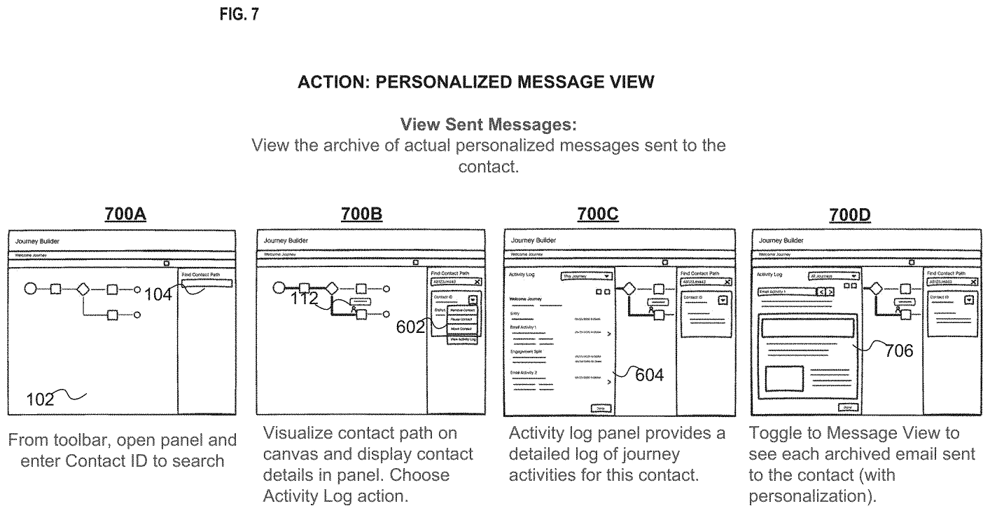

As previously disclosed, a journey may include actions such as sending electronic communications to a user, awaiting a communication from a user, and the like. FIG. 7 shows a process for an operator of the system to review specific communications with the selected user. The interface also may indicate at which step in the journey each communication was sent, or which steps are related to which communications. Such a process and interface may be useful, for example, in configurations in which the communications sent to individual users are customized for the user and thus each communication associated with a particular step or path of the journey may not be the same for all users. As shown in FIG. 7, GUI screens 700A, 700B, and 700C are similar to GUI screens 600A, 600B, and 600C in that search field 104 may be used to search for a particular contact in GUI screen 700A, an action may be selected from action list 602 in GUI screen 700B, and activity log 604 may be displayed in GUI screen 700C. As shown in GUI screen 700D, a message view 706 may be toggled for each activity within the activity log. Message view 706 may display, for example, the contents of an archived email sent to the contact. Message view 706 may also display, for example, any response sent by the contact and/or any interaction the contact may have had with the message.

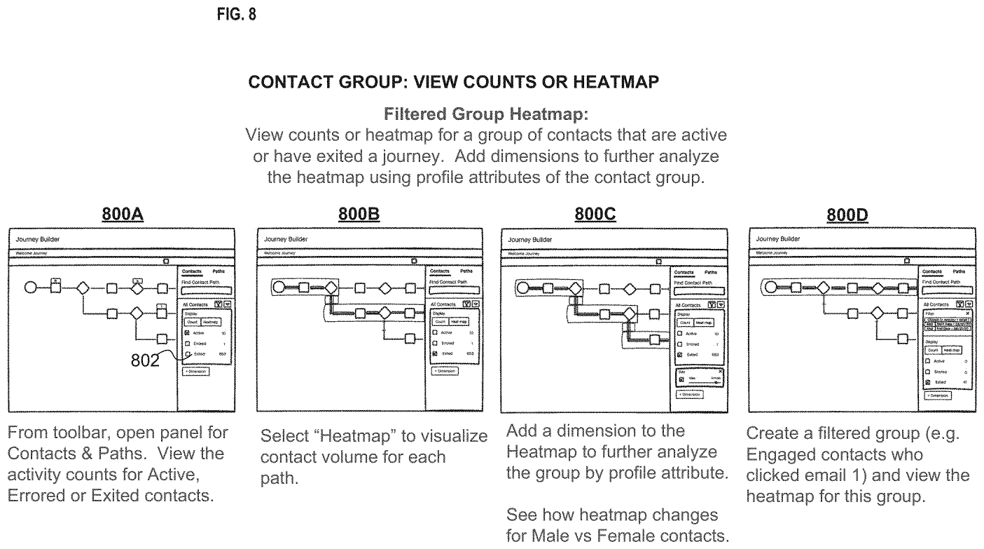

The previously-described examples and interfaces may be used to manipulate a single user's position in, and movement through, one or more journeys. More generally, the same or corresponding interfaces may be used to manage multiple users at once, especially where they are at a common point in a journey. For example, instead of selecting and receiving information about a single user and then taking action with respect to that user, a list of users may be presented for any point in the journey, and the group may be manipulated together as a single entity. For example, all users at a particular point in a journey may be paused, moved to a different point in the journey, or the like. In some cases, journeys may be used to manage groups of users collectively in addition to individual users or groups of users that are manipulated in a common way. FIG. 8 shows a process and interface for analyzing a “heatmap” showing the relative proportion of users in a group engaged in a journey that have followed various paths within the journey. Such an interface may, for example, allow a user to observe or determine trends of user groups without analyzing individual users. Other similar or associated interfaces may provide information about the group, sub-groups, and/or individual users in the group. For example, as shown in GUI screen 800A, an activity count panel 802 may show activity counts for active contacts, errored contacts, and exited contacts. As shown in GUI screen 800B, a “heatmap” may be visually depicted within the canvas. As shown in GUI screen 800C, a dimension may be added to the “heatmap” in order to further analyze the group by a profile attribute. As shown in GUI screen 800D, a filtered group may be created and a corresponding “heatmap” for the filtered group may be shown. For example, the filtered group may include engaged contacts that clicked on email 1.

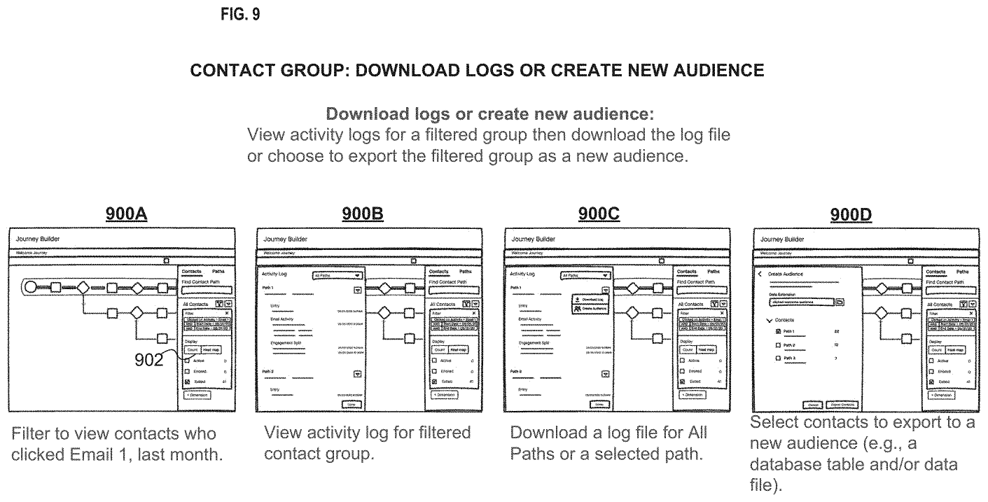

FIG. 9 shows a similar interface that allows for further manipulation of a group, such as to download data, create a new group or sub-group (“audience”), or the like. For example, as shown in GUI screen 900A, a filtered group may include contacts who clicked email 1 last month. As shown in GUI screen 900B, an activity log for the filtered group may be shown. As shown in GUI screen 900C, a log file may be downloaded. The log file may correspond, for example, to all paths or a selected path. As shown in GUI screen 900D, contacts may be selected, for example, in order to export to a new audience.

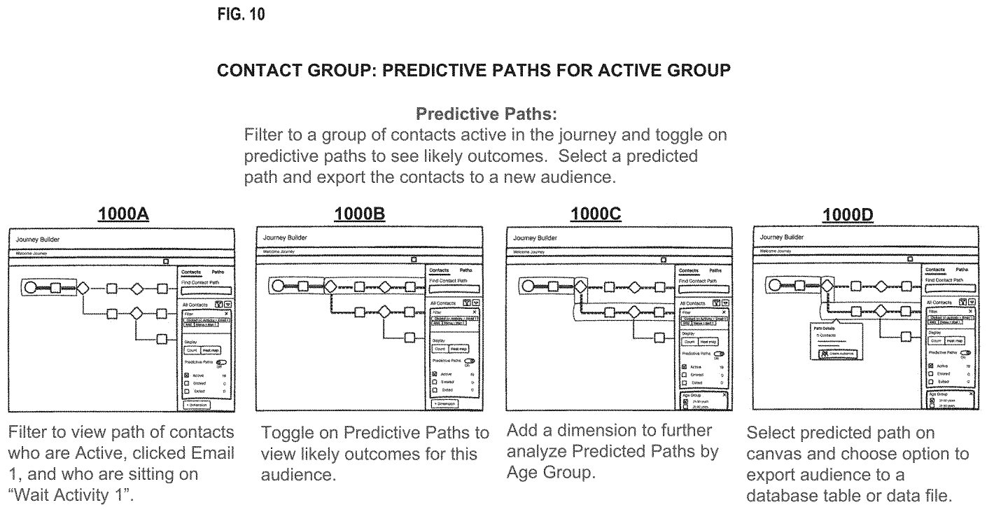

As previously disclosed, in some cases an automated prediction or recommendation system may be used to obtain further insight of user behavior on a journey or path. FIG. 10 shows a process that shows likely outcomes for one or more paths within a journey. Such predictions may be based, for example, on historical data for the users in the group or similar users and/or groups of users in the same or similar paths or journeys. As shown in GUI screen 1000A, contacts may be filtered to show, for example, a path of contacts who are active, clicked email 1, and are sitting on wait activity 1. As shown in GUI screen 1000B, predictive paths may be toggled, for example, to view likely outcomes for this audience as it progresses through journeys. As shown in GUI screen 1000C, a dimension may be added, for example, to further analyze predicted paths by age group. As shown in GUI screen 1000D, a predicted path may be selected and an option may be chosen, for example, to export audience data to a database table or data file.

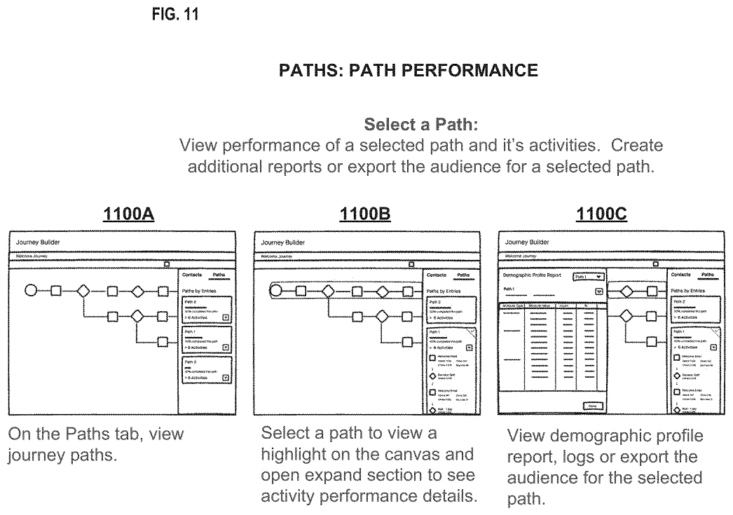

Similarly, FIG. 11 shows a process and interface for viewing performance of a selected path for a group of users. Information may include, for example, demographic information for the group of users, historical performance of the path or journey, communication and activity logs, or the like. As shown in GUI screen 1100A, journey paths may be shown, for example, on a paths tab. As shown in GUI screen 1100B, a particular path may be selected to be highlighted on the canvas and an expanded section may be opened in order to see activity performance details. As shown in GUI screen 1100C, a demographic profile report or logs for the selected path may be viewed and the audience for the selected path may be exported.

The present disclosure includes descriptions of example embodiments for purposes of illustration. It will be understood that variations, modifications, and other embodiments may be used without departing from the scope and content of the invention disclosed herein.

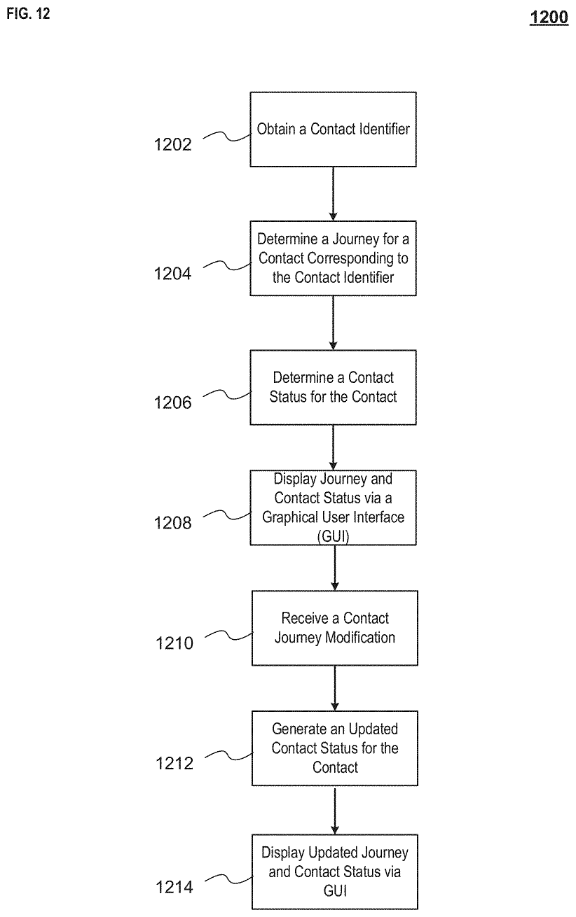

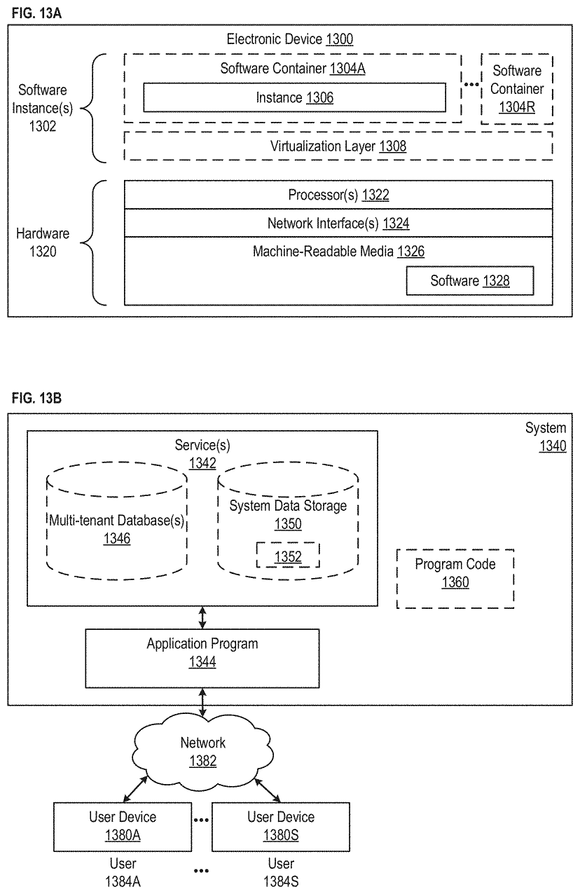

FIG. 12 illustrates a method 1200 for use with managing user journeys through predefined communication activities. The method 1200 may be performed in conjunction with or otherwise generate one or more of the various GUI screens as shown in FIGS. 1-11. In various implementations, the steps of method 1200 may be performed by a server, such as electronic device 1300 of FIG. 13A or system 1340 of FIG. 13B. Alternatively, or in addition, some or all of the steps may be performed by a user device, such as user device 1380A of FIG. 13B. Although the steps of method 1200 are presented in a particular order, this is only for simplicity.

In step 1202, a contact identifier may be obtained. For example, an operator of the system may enter or otherwise select a contact identifier. In one implementation, an operator may enter the contact identifier via a search field, such as search field 104.

In step 1204, a journey for a contact corresponding to the contact identifier may be determined. For example, after an operator of the system enters the contact identifier into a search field, a search may be performed based on the contact identifier. Once a contact corresponding to the contact identifier is identified, a journey for the contact may be determined.

In step 1206, a contact status for the contact is determined. In various implementations, the contact status may include, for example, an identification of a path within the journey on which the contact is currently located, a location of the contact within the journey, a status of the contact (e.g., active, paused, removed, etc.), and/or similar information related to the contact.

In step 1208, the journey and the contact status may be displayed via a graphical user interface (GUI). For example, as shown in the various GUI screens of FIGS. 1-11, a journey and a visual depiction of the contact on the journey may be displayed via a GUI. In addition, or alternatively, a textual description of the journey and the contact may be displayed via the GUI.

In step 1210, a contact journey modification may be received. In various implementations, a contact journey modification may include, for example, a move, a pause, a remove, an alternate path selection, and/or other similar actions to be taken in relation to the contact within the journey.

In step 1212, an updated contact status for the contact may be generated. For example, if the contact journey modification is a move, the updated contact status may indicate a new location for the contact within the journey. Similarly, if the contact journey modification is a pause, for example, the updated contact status may indicate that the contact is paused within the journey.

In step 1214, the updated journey and the updated contact status may be displayed via the GUI. For example, if the contact journey modification is a move, the contact may be visually depicted at the new location along the journey and the updated contact status may be shown via the GUI.

In this way, an operator of the system may manage user journeys through predefined communication activities. That is, the operator may be able to change where a contact is along a journey and/or how the contact interacts with the journey. The operator may also be able to identify further information about the contact and/or other similar or otherwise related contacts.

Each interface and operation disclosed herein related to a particular journey interface may be linked to one or more operations in associated databases that store information about the user(s) and journey(s) being viewed and manipulated by a user. For example, moving a user from one point in a journey to another point in the journey or to another journey may cause one or more database tables to be updated to reflect the change in the user's position within a journey. The databases may be updated based upon the contact identifier that is obtained and used during manipulation of the interfaces as previously disclosed herein, which may be the same identifier used in the database tables or may be linked to one or more other identifiers used to track and manage the user(s) journey within the database tables. In a similar example, moving a group from one point in a journey to another point in the journey or to another journey may also cause one or more database tables to be updated. In another example, pausing a user within a journey may cause one or more database tables to be updated to reflect the change in the user's status within a journey. In yet another example, one or more database tables may be referenced to determine information about a user or a group of users. For example, the contact identifier that is obtained and used during manipulation of the interfaces as previously disclosed herein may be utilized to query or otherwise access one or more database tables to determine a status and/or other information of a corresponding user. In still a further example, an action performed based on a user's or group's position within a journey and/or in response to a user's or group's engagement may also cause one or more database tables to be updated to reflect performance of the action. For example, when a user is moved to a new position within a journey due to engagement (or lack of engagement) by the user, such action may cause one or more database tables to be updated to reflect the user's engagement and the user's updated position within the journey.

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals—such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as serves) to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

FIG. 13A is a block diagram illustrating an electronic device 1300 according to some example implementations. FIG. 13A includes hardware 1320 comprising a set of one or more processor(s) 1322, a set of one or more network interfaces 1324 (wireless and/or wired), and machine-readable media 1326 having stored therein software 1328 (which includes instructions executable by the set of one or more processor(s) 1322). The machine-readable media 1326 may include non-transitory and/or transitory machine-readable media. Each of the previously described clients may be implemented in one or more electronic devices 1300. In one implementation: 1) each of the clients is implemented in a separate one of the electronic devices 1300 (e.g., in end user devices where the software 1328 represents the software to implement clients to interface directly and/or indirectly with the management of user journeys through predefined communication activities (e.g., software 1328 represents a web browser, a native client, a portal, a command-line interface, and/or an application programming interface (API) based upon protocols such as Simple Object Access Protocol (SOAP), Representational State Transfer (REST), etc.)); 2) the management of user journeys through predefined communication activities is implemented in a separate set of one or more of the electronic devices 1300 (e.g., a set of one or more server devices where the software 1328 represents the software to implement the management of user journeys through predefined communication activities); and 3) in operation, the electronic devices implementing the clients and the management of user journeys through predefined communication activities would be communicatively coupled (e.g., by a network) and would establish between them (or through one or more other layers and/or other services) connections for submitting requests to the management of user journeys through predefined communication activities service and returning responses to the clients. Other configurations of electronic devices may be used in other implementations (e.g., an implementation in which the client and the management of user journeys through predefined communication activities service are implemented on a single one of electronic device 1300).

During operation, an instance of the software 1328 (illustrated as instance 1306 and referred to as a software instance; and in the more specific case of an application, as an application instance) is executed. In electronic devices that use compute virtualization, the set of one or more processor(s) 1322 typically execute software to instantiate a virtualization layer 1308 and one or more software container(s) 1304A-1304R (e.g., with operating system-level virtualization, the virtualization layer 1308 may represent a container engine running on top of (or integrated into) an operating system, and it allows for the creation of multiple software containers 1304A-1304R (representing separate user space instances and also called virtualization engines, virtual private servers, or jails) that may each be used to execute a set of one or more applications; with full virtualization, the virtualization layer 1308 represents a hypervisor (sometimes referred to as a virtual machine monitor (VMM)) or a hypervisor executing on top of a host operating system, and the software containers 1304A-1304R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 1328 is executed within the software container 1304A on the virtualization layer 1308. In electronic devices where compute virtualization is not used, the instance 1306 on top of a host operating system is executed on the “bare metal” electronic device 1300. The instantiation of the instance 1306, as well as the virtualization layer 1308 and software containers 1304A-1304R if implemented, are collectively referred to as software instance(s) 1302.

Alternative implementations of an electronic device may have numerous variations from that described above. For example, customized hardware and/or accelerators might also be used in an electronic device.

FIG. 13B is a block diagram of a deployment environment according to some example implementations. A system 1340 includes hardware (e.g., a set of one or more server devices) and software to provide service(s) 1342, including the services disclosed herein. In some implementations the system 1340 is in one or more datacenter(s). These datacenter(s) may be: 1) first party datacenter(s), which are datacenter(s) owned and/or operated by the same entity that provides and/or operates some or all of the software that provides the service(s) 1342; and/or 2) third-party datacenter(s), which are datacenter(s) owned and/or operated by one or more different entities than the entity that provides the service(s) 1342 (e.g., the different entities may host some or all of the software provided and/or operated by the entity that provides the service(s) 1342). For example, third-party datacenters may be owned and/or operated by entities providing public cloud services.

The system 1340 is coupled to user devices 1380A-1380S over a network 1382. The service(s) 1342 may be on-demand services that are made available to one or more of the users 1384A-1384S working for one or more entities other than the entity which owns and/or operates the on-demand services (those users sometimes referred to as outside users) so that those entities need not be concerned with building and/or maintaining a system, but instead may make use of the service(s) 1342 when needed (e.g., when needed by the users 1384A-1384S). The service(s) 1342 may communicate with each other and/or with one or more of the user devices 1380A-1380S via one or more APIs (e.g., a REST API). In some implementations, the user devices 1380A-1380S are operated by users 1384A-1384S, and each may be operated as a client device and/or a server device. In some implementations, one or more of the user devices 1380A-1380S are separate ones of the electronic device 1300 or include one or more features of the electronic device 1300.

In some implementations, the system 1340 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants.

In one implementation, the system 1340 is a multi-tenant cloud computing architecture supporting multiple services, such as one or more of the following types of services: Customer relationship management (CRM); Configure, price, quote (CPQ); Business process modeling (BPM); Customer support; Marketing; External data connectivity; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Analytics; Community; Internet-of-Things (IoT); Industry-specific; Artificial intelligence (AI); Application marketplace (“app store”); Data modeling; Security; and Identity and access management (IAM).

For example, system 1340 may include an application platform 1344 that enables PAAS for creating, managing, and executing one or more applications developed by the provider of the application platform 1344, users accessing the system 1340 via one or more of user devices 1380A-1380S, or third-party application developers accessing the system 1340 via one or more of user devices 1380A-1380S.

In some implementations, one or more of the service(s) 1342 may use one or more multi-tenant databases 1346, as well as system data storage 1350 for system data 1352 accessible to system 1340. In certain implementations, the system 1340 includes a set of one or more servers that are running on server electronic devices and that are configured to handle requests for any authorized user associated with any tenant (there is no server affinity for a user and/or tenant to a specific server). The user devices 1380A-1380S communicate with the server(s) of system 1340 to request and update tenant-level data and system-level data hosted by system 1340, and in response the system 1340 (e.g., one or more servers in system 1340) automatically may generate one or more Structured Query Language (SQL) statements (e.g., one or more SQL queries) that are designed to access the desired information from the multi-tenant database(s) 1346 and/or system data storage 1350.

In some implementations, the service(s) 1342 are implemented using virtual applications dynamically created at run time responsive to queries from the user devices 1380A-1380S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 1360 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 1344 includes an application setup mechanism that supports application developers' creation and management of applications, which may be saved as metadata by save routines. Invocations to such applications, including the journey management service, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 1382 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 4^{th} generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 1340 and the user devices 1380A-1380S.

Each user device 1380A-1380S (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 1340. For example, the user interface device can be used to access data and applications hosted by system 1340, and to perform searches on stored data, and otherwise allow one or more of users 1384A-1384S to interact with various GUI pages that may be presented to the one or more of users 1384A-1384S. User devices 1380A-1380S might communicate with system 1340 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 1380A-1380S might include an HTTP client, commonly referred to as a “browser,” for sending and receiving HTTP messages to and from server(s) of system 1340, thus allowing users 1384A-1384S of the user devices 1380A-1380S to access, process and view information, pages and applications available to it from system 1340 over network 1382.

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting.

What is claimed is:

1. A computer-implemented for management of user journeys through predefined communication activities by a computerized information system, the method comprising:
obtaining a contact identifier for one or more contacts in the computerized information system;
determining a journey for a contact corresponding to the contact identifier, the journey comprising one or more paths and each path comprising one or more actions to be performed in relation to the contact;
determining a contact status for the contact, the contact status including a location of the contact along the journey and a state of the contact;
displaying, via a graphical user interface, a visual depiction of the journey and a visual depiction of the contact status for the contact;
receiving an indication of a contact journey modification;
generating an updated contact status for the contact based on the contact journey modification; and
displaying, via the graphical user interface, an updated visual depiction of the journey and the updated contact status for the contact.

2. The computer-implemented method of claim 1, wherein obtaining the contact identifier comprises:
receiving a selection of a location on the journey;
providing an indication of contacts currently at the location;
receiving a selection of the contact from the user; and
retrieving the contact identifier based on the selection of the contact.

3. The computer-implemented method of claim 2, wherein providing an indication of contacts currently at the location comprises:
submitting a query to a database based on the location;
receiving a response from the database, the response including the indication of contacts currently at the location; and
displaying, via the graphical user interface, the indication of contacts currently at the location.

4. The computer-implemented method of claim 2, wherein retrieving the contact identifier based on the selection of the contact comprises:
submitting a query to a database based on the selection of the contact; and
receiving a response from the database, the response including the contact identifier corresponding to the selection of the contact.

5. The computer-implemented method of claim 1, wherein generating an updated contact status for the contact based on the contact journey modification comprises:
determining the contact journey modification is a move modification; and
generating the updated contact status to further include a new location to which the contact will be moved along the journey.

6. The computer-implemented method of claim 1, wherein generating an updated contact status for the contact based on the contact journey modification comprises:
determining the contact journey modification is an alternative path modification;
recommending an alternative path or an alternative journey; and
generating the updated contact status to further include a new location of the contact along the alternative path or the alternative journey.

7. The computer-implemented method of claim 1, further comprising updating a stored record for the contact in a database based on the indication of the contact journey modification.

8. The computer-implemented method of claim 1, further comprising performing an action based on the contact journey modification and the updated contact status.

9. A non-transitory machine-readable storage medium that provides instructions that, if executed by a processor, are configurable to cause the processor to perform operations comprising:
obtaining a contact identifier for one or more contacts in the computerized information system;
determining a journey for a contact corresponding to the contact identifier, the journey comprising one or more paths and each path comprising one or more actions to be performed in relation to the contact;
determining a contact status for the contact, the contact status including a location of the contact along the journey and a state of the contact;
displaying, via a graphical user interface, a visual depiction of the journey and a visual depiction of the contact status for the contact;
receiving an indication of a contact journey modification;
generating an updated contact status for the contact based on the contact journey modification; and
displaying, via the graphical user interface, an updated depiction of the journey and the updated contact status for the contact.

10. The non-transitory machine-readable storage medium of claim 9, wherein obtaining the contact identifier comprises:
receiving a selection of a location on the journey;
providing an indication of contacts currently at the location;
receiving a selection of the contact from the user; and
retrieving the contact identifier based on the selection.

11. The non-transitory machine-readable storage medium of claim 9, wherein generating an updated contact status for the contact based on the contact journey modification comprises:
determining the contact journey modification is a move modification; and
generating the updated contact status to further include a new location to which the contact will be moved along the journey.

12. The non-transitory machine-readable storage medium of claim 9, wherein generating an updated contact status for the contact based on the contact journey modification comprises:
determining the contact journey modification is an alternative path modification;
recommending an alternative path or an alternative journey; and
generating the updated contact status to further include a new location of the contact along the alternative path or the alternative journey.

13. The non-transitory machine-readable storage medium of claim 9, wherein the instructions are further configurable to cause the processor to perform further operations comprising updating a stored record for the contact in a database based on the indication of the contact journey modification.

14. The non-transitory machine-readable storage medium of claim 9, wherein the instructions are further configurable to cause the processor to perform further operations comprising performing an action based on the contact journey modification and the updated contact status.

15. An apparatus comprising:
a processor;
a non-transitory machine-readable storage medium that provides instructions that, if executed by the processor, are configurable to cause the apparatus to perform operations comprising:
obtaining a contact identifier for one or more contacts in the computerized information system;
determining a journey for a contact corresponding to the contact identifier, the journey comprising one or more paths and each path comprising one or more actions to be performed in relation to the contact;
determining a contact status for the contact, the contact status including a location of the contact along the journey and a state of the contact;
displaying, via a graphical user interface, a visual depiction of the journey and a visual depiction of the contact status for the contact;
receiving an indication of a contact journey modification;
generating an updated contact status for the contact based on the contact journey modification; and
displaying, via the graphical user interface, an updated depiction of the journey and the updated contact status for the contact.

16. The apparatus of claim 15, wherein obtaining the contact identifier comprises:
receiving a selection of a location on the journey;
providing an indication of contacts currently at the location;
receiving a selection of the contact from the user; and
retrieving the contact identifier based on the selection.

17. The apparatus of claim 15, wherein generating an updated contact status for the contact based on the contact journey modification comprises:
determining the contact journey modification is a move modification; and
generating the updated contact status to further include a new location to which the contact will be moved along the journey.

18. The apparatus of claim 15, wherein generating an updated contact status for the contact based on the contact journey modification comprises:
determining the contact journey modification is an alternative path modification;
recommending an alternative path or an alternative journey; and
generating the updated contact status to further include a new location of the contact along the alternative path or the alternative journey.

19. The apparatus of claim 15, wherein the instructions are further configurable to cause the apparatus to perform further operations comprising updating a stored record for the contact in a database based on the indication of the contact journey modification.

20. The apparatus of claim 15, wherein the instructions are further configurable to cause the apparatus to perform further operations comprising performing an action based on the contact journey modification and the updated contact status.
